(19) United States
(12) Patent Application Publication
(10) Pub. No.: US 2006/0021949 A1
(43) Pub. Date: Feb. 2, 2006

(54) Apparatus and process for extruding poly (arylene ether) blends

(76) Inventors: Michael F. Dolan, Guilderland, NY (US); Dan C. Friebel, Lake Luzerne, NY (US); Robert Hossan, Delmar, NY (US); Kenneth V. Hunter, Troy, NY (US); Carol A. Rhoads, Delmar, NY (US); David A. Washburn, Menands, NY (US)

Correspondence Address: CANTOR COLBURN, LLP, 55 GRIFFIN ROAD SOUTH, BLOOMFIELD, CT, 06002, US

(21) Appl. No.: 11/182,683

(22) Filed: Jul. 15, 2005

Related U.S. Application Data
(63) Continuation-in-part of application No. 10/903,162, filed on Jul. 30, 2004.

(51) Int. Cl. C02F 1/00

(52) U.S. Cl. 210/741

(57) ABSTRACT

An apparatus for extruding a poly(arylene ether) blend comprises a continuous screen changer disposed between a die and an extruder. The continuous screen changer comprises an extruder block, an outlet block which is in fluid communication with the extruder block, a reel of filtering means which is disposed to allow passage of the screen through the extruder block and out the outlet block; and, a means for control of screen advancement through the extruder block and outlet block.

### CROSS REFERENCE TO RELATED APPLICATIONS

This application is a continuation in part of U.S. patent application Ser. No. 10/903,162 filed on Jul. 30, 2004, which is incorporated by reference herein.

### BACKGROUND OF THE INVENTION

This disclosure relates to an apparatus and process for extruding poly(arylene ether) blends, and in particular to a filtering apparatus.

Poly(arylene ether) blends are useful in the manufacture of articles and components for a wide range of applications, from automotive parts to electronic appliances. Under some conditions poly(arylene ether) blends may contain some degradation products, possibly resulting from the high heat usually involved in the melt mixing of the blends. The degradation products can manifest themselves as dark particulates or streaking in the blends. There is a demand with certain applications for poly(arylene ether) blends that contain little to no degradation products and their resultant aesthetic aberrations. Because of this it is desirable to provide melt mixing apparatuses, particularly extrusion apparatuses, and methods of melt mixing, particularly extrusion, that can produce poly(arylene ether) blends with decreased levels of degradation products.

Decreasing the level of degradation products in heated plastic blends has been attempted by employing filters in the extrusion apparatus. These filters may reduce the level of degradation products in the heated plastic blends but consequently the filters periodically needs to be cleaned or replaced to avoid an excessive buildup of degradation products in the filters. The cleaning or replacement of these filters is difficult and disruptive to the melt mixing process.

### BRIEF SUMMARY

A method of continuously filtering a poly(arylene ether) blend comprises:
filtering the poly(arylene ether) blend from a melt mixing device through a filtering means to a die;
detecting a first pressure of the poly(arylene ether) blend before the filtering means;
detecting a second pressure of the poly(arylene ether) blend after the filtering means;
preventing advancement of the filtering means when the difference between the first pressure and the second pressure is 75% to 99% of the tensile strength of the filtering means; and
altering operation parameters to decrease the difference between the first pressure and the second pressure while advancement of the filtering means is being prevented.

In another embodiment, an apparatus for filtering a poly(arylene ether) blend comprises:
an extruder block comprising a first channel for an extruder screw and flow of the poly(arylene ether) blend, a means for multi-zonal control of the extruder block temperature, and a second channel for filtering means wherein the second channel intersects the first channel and has an inlet and an outlet, and further wherein the first channel and the second channel are disposed such that the end of the extruder screw is located within 15 millimeters of the filtering means;
a reel of filtering means disposed to allow passage of the filtering means into the inlet of the extruder block second channel;
an outlet block comprising a channel having an inlet, an exit lip and a restriction point located between the inlet and exit lip, means for cooling the outlet block channel, and means for heating the outlet block channel wherein the outlet block channel inlet is in fluid communication with the extruder block second channel outlet;
a means for sensing the advancement of the filtering means from the reel; and
a means for control of advancement of the filtering means from the reel through the extruder block and outlet block.

### BRIEF DESCRIPTION OF THE DRAWINGS

FIG. 1 is an overhead perspective view of the continuous screen changer.

FIG. 2 is a perspective view of the extruder block.

### DETAILED DESCRIPTION OF THE INVENTION

Continuous screen changers have been employed successfully in the production of non-poly(arylene ether) materials but attempts to employ these continuous screen changers in the production of poly(arylene ether) blends have not met with success and in some cases have resulted in an increase in degradation particles in the poly(arylene ether) blend.

Use of a continuous screen changer described herein has resulted in the production of poly(arylene ether) blends with a decreased level of degradation particles present in the extruded blend when compared to blends prepared without the continuous screen changer. Use of the continuous screen changer has resulted in at least a 50% decrease in the amount of visible degradation products in a poly(arylene ether) blend when compared to the same composition prepared without the continuous screen changer. The amount of visible degradation products may be determined by compression molding a specific amount of extruded material into a plaque of a specific size. The amount of visible degradation products (streaks and specks) are then counted.

As used herein, a “poly(arylene ether)” comprises a plurality of structural units of the formula (I): 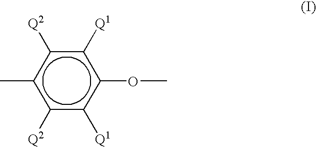
wherein for each structural unit, each Q¹ is independently halogen, primary or secondary lower alkyl (e.g., an alkyl containing 1 to about 7 carbon atoms), phenyl, haloalkyl, aminoalkyl, alkenylalkyl, alkynylalkyl, hydrocarbonoxy, and halohydrocarbonoxy wherein at least two carbon atoms separate the halogen and oxygen atoms; and each Q² is independently hydrogen, halogen, primary or secondary lower alkyl, phenyl, haloalkyl, aminoalkyl, alkenylalkyl, alkynylalkyl, hydrocarbonoxy, halohydrocarbonoxy wherein at least two carbon atoms separate the halogen and oxygen atoms. In some embodiments, each Q¹ is independently alkyl or phenyl, for example, C₁₋₄ alkyl, and each Q² is independently hydrogen or methyl. The poly(arylene ether) may comprise molecules having aminoalkyl-containing end group(s), typically located in an ortho position to the hydroxy group. Also frequently present are 4-hydroxybiphenyl end groups, typically obtained from reaction mixtures in which a by-product diphenoquinone is present.

The poly(arylene ether) may be in the form of a homopolymer; a copolymer; a graft copolymer; an ionomer; a block copolymer, for example comprising arylene ether units and blocks derived from alkenyl aromatic compounds; as well as combinations comprising at least one of the foregoing. Poly(arylene ether) includes polyphenylene ether containing 2,6-dimethyl-1,4-phenylene ether units optionally in combination with 2,3,6-trimethyl-1,4-phenylene ether units.

The poly(arylene ether) may be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

The poly(arylene ether) can have a number average molecular weight of 3,000 to 40,000 atomic mass units (amu) and a weight average molecular weight of 5,000 to 80,000 amu, as determined by gel permeation chromatography. The poly(arylene ether) can have an intrinsic viscosity of 0.10 to 0.60 deciliters per gram (dl/g), or, more specifically, 0.29 to 0.48 dl/g, as measured in chloroform at 25° C. It is possible to utilize a combination of high intrinsic viscosity poly(arylene ether) and a low intrinsic viscosity poly(arylene ether). Determining an exact ratio, when two intrinsic viscosities are used, will depend somewhat on the exact intrinsic viscosities of the poly(arylene ether) used and the ultimate physical properties that are desired.

The poly(arylene ether) may be blended with vinyl aromatic resins such as polystyrene and rubber modified polystyrene, polyamide, and/or polyolefin. The blends may further comprise additional components such as additives, impact modifiers and filler with the proviso that the additional components pass through the screen. In the case of fillers it shall be understood that the filler should be sized such that greater than or equal to 95 weight percent, or, more specifically, 100 weight percent of filler, based on the total weight of the filler, passes through the screen.

A method of continuously filtering a poly(arylene ether) blend melt comprises filtering the poly(arylene ether) blend from a melt mixing device through a filtering means to a die. The filtering means exposed to the melt gradually becomes clogged during continuous filtration and at least a portion of the filtering means exposed to the melt must be replaced. The pressure exerted by the poly(arylene ether) blend flow forces the filtering means out of the extruder block. The filtering means exiting the extruder block is at least partially embedded in the material being filtered. The embedded filtering means proceeds to an outlet block where it cools to form a solid mass that acts as a plug to prevent filtering means advancement. Replacement of the filtering means occurs by heating the outlet block channel, thus softening at least the exterior of the plug and allowing it and the filtering means to advance under the pressure exerted by the poly(arylene ether) blend. Replacement of the filtering means can occur when the upstream pressure reaches or exceeds a preset value, at regular intervals based on time or the amount of material produced or a combination of the foregoing.

However instances can occur when the pressure differential between the upstream pressure and the downstream pressure can exceed the tensile strength of the filtering means, resulting in a rupture or tear. Thus it is important that the pressure of the poly(arylene ether) blend melt before the filtering means (the upstream pressure) and after the filtering means (the downstream pressure) be monitored and the pressure difference between the upstream and downstream pressures be maintained at a level that is less than or equal to 75% of the tensile strength of the filtering means. When the pressure difference between the upstream and downstream pressures is greater than 75% of the tensile strength of the filtering means, or, more specifically, 75% to 100%, or even more specifically 75-90%, or, even more specifically, 75-85% of the tensile strength of the filtering means, outlet block channel heating is prevented. While heating of the outlet block is being prevented in response to the pressure differential operating parameters are modified to decrease the pressure differential. Once the pressure differential is less than 75% of the tensile strength heating of the outlet block channel is once again permitted. Exemplary operating parameters that can be modified include decreasing the rate at which material is added to the extruded and/or increasing the extruder temperature.

A “melt mixing device” comprises an apparatus suitable for mixing polymers and optionally other ingredients in melt. A melt mixing device may comprise an extruder or series of extruders, melt reactor with a metering pump, and/or other means of melt mixing that is capable of creating sufficient pressure to facilitate screen advancement. Types of extruders that may be used include single screw extruders, multiple screw extruders, tandem extruders and the like.

In one embodiment, a method of continuously filtering a poly(arylene ether) blend in melt comprises forming the poly(arylene ether) blend in melt and filtering the blend. In another embodiment a pre-formed poly(arylene ether) blend, typically in the form of pellets or the like, can be melted in an extruder or other melt mixing device and filtered.

Filtering means may be defined as materials capable of withstanding the temperatures and pressures employed in a poly(arylene ether) melt filtration process. Exemplary materials include for example, a woven stainless steel wire screen using weaves such as a Reverse Dutch Twill Weave, Chevron, or Broken Weave. The mesh size of the filtering means may be chosen based upon the amount and/or size of degradation particles acceptable in the filtered material. In one embodiment, the mesh size of the filtering means is 40 to 500, or, more specifically, 40 to 250, or even more specifically, 60 to 150. As used herein the diameter of the openings in the filtering means is equal to 21900 divided by the mesh size raised to the power of 1.09. Thus a mesh size of 40 corresponds to openings having a diameter of 393 micrometers and a mesh size of 500 corresponds to openings having a diameter of 25 micrometers. When a filtering means has openings of a particular size particles greater than that size will not pass through.

The filtering means may be replaced with new filtering means in regular increments of 5 to 20% of the total area of filtering means exposed to the polymer melt. When initiating new color or product changes the increment may be 50 to 100%.

In one embodiment a method of continuously filtering a poly(arylene ether) blend in melt comprises forming the poly(arylene ether) blend in melt in an extruder, extruding the poly(arylene ether) through a filtering means located across the extrusion channel of an extruder block of a continuous screen changer under an upstream pressure less than 9.6 megapascals (1400 pounds per square inch), and a pressure differential (upstream pressure-downstream pressure) less than or equal to 8.2 megapascals (1200 pounds per square inch).

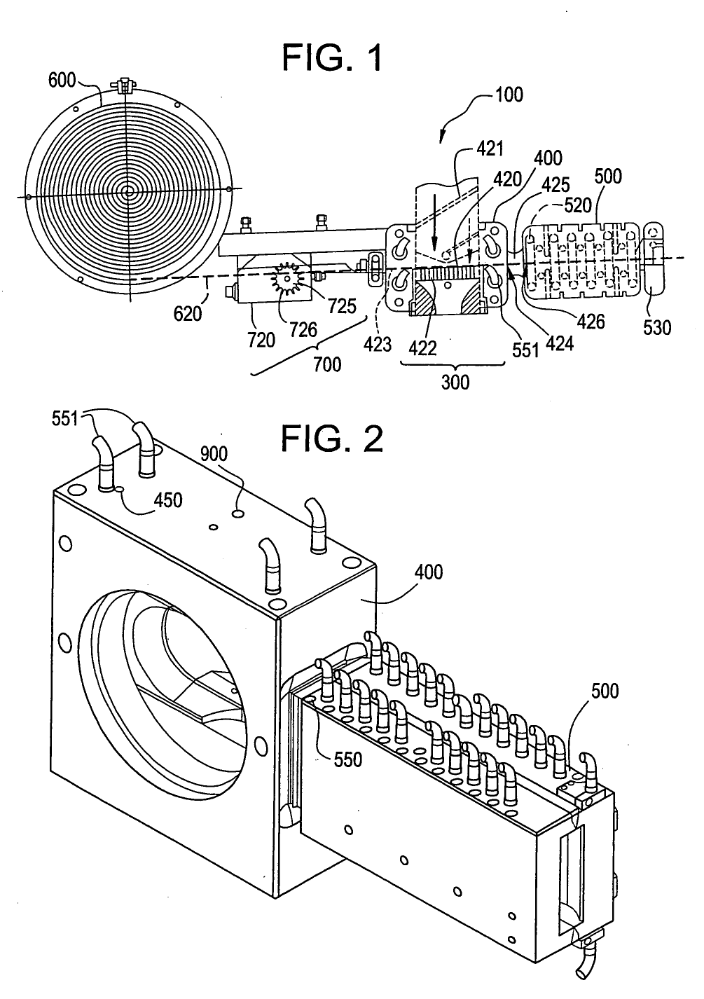

Referring initially to FIG. 1 a top cut away view of a continuous screen changer 300 is shown comprising an extruder block 400, an outlet block 500, a ribbon reel 600 and a means for detecting filtering means advancement 700. The extruder block 400 comprises a channel 420 (also defined as the extrusion channel) extending through the extruder block 400 which provides a means of flow for the poly(arylene ether) blend which is indicated by the bold arrow. The extruder includes, among other components, an extruder screw 421 that drives the means of flow. The end of the extruder screw is located less than or equal to 15 millimeters from the filtering means. A breaker plate 422 provides support for a filtering means such as a screen 620 extending from reel 600 through outlet block 500 across the extrusion channel in extruder block 500. Pressure (shown by dotted arrow) will be inherent to the extrusion process due to the high viscosity of poly(arylene ether) blend and the presence of the screen. The extruder block 400 may also comprises two or more thermocouples 450, one of which is shown in FIG. 2, used to detect the temperature of the extruder. block to prevent over heating of the poly(arylene ether) blend and heater rods 551 to heat the extruder block. In one embodiment the extruder block thermocouples are distributed to permit zonal temperature control of the extruder block and to compensate for environmental temperature variations. In one embodiment, the temperature sensing section of the thermocouple may be located within 10-20% of the midpoint of the height of the extruder block. In another embodiment thermocouples 450 may be located such that the detected temperature is within 10% of the actual temperature of the poly(arylene ether) blend. The detected temperature may be within 5%, or, more specifically, within 2% of the actual temperature of the poly(arylene ether) blend. The temperature of the extruder block is maintained at a temperature sufficient for blend flow but less than the degradation temperature of the poly(arylene ether) blend, for example less than 260° C. for a poly(arylene ether)/polystyrene blend.

The temperature of the extruder block may be additionally controlled by a thermocouple located in the molten poly(arylene ether) blend.

The extruder block further comprises a pressure sensor (900 in FIG. 2) for determination of the upstream pressure. A pressure sensor for the downstream pressure (not shown) is located after the filtering means, typically in the die. The upstream pressure may be used to monitor the operation of the continuous filtration and initiate corrective action under specified conditions. For example, if the upstream pressure is greater than or equal to 8.96 megapascals (1300 pounds per square inch), an operator notification alarm is triggered. If the pressure is greater than or equal to 9.6 megapascals (1400 pounds per square inch) a system fault is triggered and the addition of material to the extruder is halted. If the pressure is greater than or equal to 10.3 megapascals (1500 pounds per square inch) a system fault is triggered and the extrusion process is halted.

If the pressure differential between the upstream and downstream pressures exceeds 5.2 megapascals (750 pounds per square inch) an alarm state may be triggered, notifying the operator and initiating cooling of the outlet block and preventing heating of the outlet block.

In one embodiment the extruder block is configured to permit the removal of the extruder screws from the die side to permit easy access for screw removal through the screen changer.

When the filtering means is replaced with fresh filtering means from reel 600, the pressure of the poly(arylene ether) blend forces the used screen and a portion of poly(arylene ether) blend out of the extruder block via outlet 424 and into the outlet block via outlet block inlet 426. Extruder block inlet 423 may be cooled to prevent leakage of the poly(arylene ether) blend. In the outlet block the molten poly(arylene ether) cools and at least at the exit lip 522 of the outlet block 500 forms a plug, sealing the system and preventing further advancement of the filtering means and poly(arylene ether) through the outlet block. When replacement of a portion of the filtering means is required the outlet block is heated using the outlet block heaters (including the exit lip heater 530, an optional restriction point heater and an optional outlet block inlet heater) which softens the plug to permit movement of the material in the outlet block and hence movement of the filtering means across the extrusion channel with concurrent introduction of fresh filtering means. The outlet block heaters work in concert with the filtering means advancement sensor 700. The filtering means advancement sensor detects movement of the filtering means and when the filtering means has advanced 20 to 100% of the total desired advancement turns off the outlet block heater and initiates cooling of the outlet block and formation of the plug.

The plug may be of a polymer or polymer blend that is different than the poly(arylene ether) blend being extruded, due to the ability to use the system for multiple blends. The entire system (extruder, screen changer and die head) may be flushed with a different polymer or polymer blend between different poly(arylene ether) blends. Notably the different polymer or polymer blend within the plug may have different physical properties such as melt temperature and melt flow.

The length and interior configuration of the outlet block may be chosen based upon the amount of screen advancement required at each interval. The interior configuration may comprise a restriction point located between the inlet and the exit lip. Typically the screen advances 5 to 100% of the total length of screen in the exposed area in the extrusion channel. The length of the outlet block must be long enough to permit adequate cooling of the poly(arylene ether) blend to permit the formation of a plug at the exit lip. The outlet block may be heated by a single heater or several heaters. In some cases heaters may be present at the restriction point, inlet, and/or the exit lip.

The outlet block further comprises an exit tray located below the exit lip. The exit tray comprises a thermocouple, which in the event molten material exits the outlet block, will trigger a system fault that halts extrusion. The outlet block may optionally comprise a detector for coolant flow in the cooling means, a temperature sensor to detect the outlet block temperature and an inlet temperature sensor. If the coolant flow detector fails to detect coolant flow an alarm is initiated to notify the operator of a potentially compromising event. If the temperature sensor fails to detect a decrease in outlet block temperature after 20 seconds an alarm may be initiated to notify the operator of a potentially compromising event. If the inlet temperature sensor detects an inlet temperature above acceptable limits an alarm is initiated to notify the operator of a potentially compromising event.

The amount of screen advancement may be determined by the programmable encoder assembly 720. The programmable encoder assembly may comprise a gear 725 having splines 726 which are in communication with the screen 620. The programmable encoder assembly 720 may be programmed with a predetermined amount of splines 726 on gear 725 that may be advanced before the termination of heating of the outlet block exit lip. Residual heat contained in the poly(arylene ether) blend permits continued screen advancement to the desired amount before the formation of the plug 521 at the exit lip 522. The predetermined amount of splines 726 may be dependent upon factors such as such as the specific poly(arylene ether) blend being extruded, the specific screen being used, the pressure and the need to move fresh screen for color changes. If the programmable encoder assembly detects filtering means advancement beyond an acceptable amount an alarm is initiated to notify the operator of a potentially compromising event.

The continuous screen changer may be used in combination with a die. In one embodiment the die is a low inventory die head. The low inventory die head reduces residence time of the poly(arylene ether) blends after the continuous screen changer and reduces or eliminates hang up points where degradation products could form and minimizes changeover time between grade and color changes. The die may be one of the kinds described in U.S. Pat. No. 6,126,430 and U.S. Pat. No. 6,196,823. Generally, the die may comprise a mounting and/or connecting structure, a die body, a clamp collar assembly, and a pivot assembly. In one embodiment the die is mounted to provide easy access to the screen changer. The die head provides strands of the poly(arylene ether) blend that may then be pelletized.

In addition to screen advancement based at least on differential pressure, the apparatus may additionally be operated in a manual mode, allowing for operator controlled heating of the outlet block, typically to permit manual advancement of the filtering means. The apparatus may also have a off (cut) mode that prevents heating and maintains the cooling of the outlet block. One purpose is to prevent filtering means advancement and permit cutting of the filtering means and poly(arylene ether) blend that has exited the outlet block. The apparatus may also comprise a color coded visual warning system for the operator, with different colors corresponding to different types of alarms and system conditions. A visual system is advantageous due to the high level of noise typically present near an extruder.

The above described apparatus and method allows the removal of degradation particles from a poly(arylene ether) blend despite an increase in residence time. In addition, the method may be used when a variety of poly(arylene ether) blends are extruded in the same extruder, i.e., the composition of the material in the outlet block channel varies over time.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety.

1. A method of continuously filtering a poly(arylene ether) blend comprising:
filtering the poly(arylene ether) blend from a melt mixing device through a filtering means to a die;
detecting a first pressure of the poly(arylene ether) blend before the filtering means;
detecting a second pressure of the poly(arylene ether) blend after the filtering means;
preventing advancement of the filtering means when the difference between the first pressure and the second pressure is 75% to 99% of the tensile strength of the filtering means; and
altering operation parameters to decrease the difference between the first pressure and the second pressure while advancement of the filtering means is being prevented.

2. The method of claim 1, wherein the poly(arylene ether) blend comprises a vinyl aromatic resin.

3. The method of claim 1, wherein the poly(arylene ether) blend comprises polyamide.

4. The method of claim 1, wherein the melt mixing device comprises an extruder.

5. The method of claim 1, further comprising replacing at least a portion of the filtering means when the upstream pressure exceeds extruder operating parameters.

6. The method of claim 1, further comprising replacing at least a portion of the filtering means with fresh filtering means at predetermined time intervals.

7. The method of claim 6, wherein 5-20% of the filtering means is replaced with fresh filtering means.

8. The method of claim 1, further comprising replacing at least a portion of the filtering means with fresh filtering means after filtering a predetermined amount of blend.

9. The method of claim 1, wherein the filtering means comprises a woven stainless steel screen.

10. The method of claim 1, wherein the filtering means has a mesh size of 40 to 500.

11. The method of claim 1, wherein the filtering means has openings having a diameter of 25 to 393 micrometers.

12. The method of claim 1, wherein the difference between the first pressure and the second pressure is less than or equal to 8.2 megapascals.

13. An apparatus for filtering a poly(arylene ether) blend comprising:
an extruder block comprising a first channel for an extruder screw and flow of the poly(arylene ether) blend, a means for multi-zonal control of the extruder block temperature, and a second channel for filtering means intersecting the first channel and having an inlet and an outlet, wherein the first channel and the second channel are disposed such that the end of the extruder screw is located within 15 millimeters of the filtering means;
a reel of filtering means disposed to allow passage of the filtering means into the inlet of the extruder block second channel;
an outlet block comprising a channel having an inlet and an exit lip wherein the outlet block channel inlet is in fluid communication with the extruder block second channel outlet, means for cooling the outlet block channel, and means for heating the outlet block channel;
a means for sensing the advancement of the filtering means from the reel; and
a means for controlling advancement of the filtering means from the reel through the extruder block and outlet block.

14. The apparatus of claim 13 wherein the means for multi-zonal control of the extruder block temperature comprises two or more thermocouples.

15. The apparatus of claim 13, wherein the filtering means comprises a woven stainless steel wire screen having a mesh size of 40 to 500.

16. The method of claim 13, wherein the filtering means has openings having a diameter of 25 to 393 micrometers.

17. The apparatus of claim 13, wherein the extruder block further comprises a pressure sensor.

18. The apparatus of claim 13, further comprising a die wherein the die comprises a pressure sensor.

19. The apparatus of claim 13, wherein the extruder block is configured to permit screw removal on the die side.

20. The apparatus of claim 13 wherein the means for multi-zonal control of the extruder block temperature comprises a melt thermocouple.

21. A method of continuously filtering a poly(arylene ether) blend comprising:
filtering the poly(arylene ether) blend from a melt mixing device through a filtering means to a die;
detecting a first pressure of the poly(arylene ether) blend before the filtering means;
detecting a second pressure of the poly(arylene ether) blend after the filtering means;
maintaining the difference between the first pressure and the second pressure below 75% of the tensile strength of the filtering means.
